(19) United States
(12) Patent Application Publication
(10) Pub. No.: US 2012/0073284 A1
(43) Pub. Date: Mar. 29, 2012

(54) HOT ZONE HEAT TRANSFER STRUCTURE OF A STIRLING ENGINE

(75) Inventors: Tien-Ting CHEN, Tainan City (TW); Chung-Ping Liu, Taoyuan City (TW); Yin-Nan Huang, Zhongli City (TW); Po-Hung Chen, Zhubei City (TW); Yu-Ling Huang, New Taipei City (TW); Han-Hsun Yang, Tainan City (TW); Ching-Hsiang Cheng, Tainan City (TW)

(73) Assignee: MARKETECH INTERNATIONAL CORP., Taipei (TW)

(21) Appl. No.: 13/047,984

(22) Filed: Mar. 15, 2011

(30) Foreign Application Priority Data
Sep. 24, 2010 (TW) 099132294

(51) Int. Cl. F02G 1/047

(52) U.S. Cl. 60/524

(57) ABSTRACT

A hot zone heat transfer structure of a Stirling engine is provided. One end of a cylinder includes a heated head, with its end wall connected with a hot air pipe. The cylinder accommodates a piston. The piston has an end surface corresponding to the end wall, between which a hot zone is defined. The end wall is fitted with a protruding heat conductor towards the piston, and the end surface is fitted with a concave heat-conducting portion, enabling normal overlapping of the ends of both the heat conductor and the heat-conducting portion. The overlapping may vary with the changing locations of the piston. A flanged section is set externally onto said heat conductor towards the exterior of the end wall. The heat from the head can be transferred to the central area of the hot zone via the help of the heat conductor and heat-conducting portion.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a Stirling engine, and more particularly to an innovative one which is configured with a heat transfer structure for its hot zone heat transfer structure.

2. Description of Related Art Including Information Disclosed Under 37 CFR 1.97 and 37 CFR 1.98.

A Stirling engine is a highly efficient energy converter designed with a sealed gas circulating structure and regenerator. There are at least 100 types of such engines since it was invented by Robert Stirling from Edinburgh, Scotland in 1816.

Theoretically, the thermal efficiency of an ideal Stirling engine is equivalent to Carnot engine, since both of them are of reversible cycle with maximum thermal cyclic converting efficiency.

The working gas of a Stirling engine may be high-pressure air such as nitrogen, helium or hydrogen. Generally speaking, such an engine is constructed in two ways. In one, air compression or expansion is realized by a dynamic piston, and the flow of working gas in the cylinder is driven by a displacer. In another, air compression or expansion is realized by two pistons without use of displacer, and air in the cylinder is pushed to the heated portion for driving the dynamic engine.

As an external combustion engine differing from internal combustion engine (oil or diesel engine), a Stirling engine can be operated with any kind of high-temperature heat sources, such as: solar energy, waste heat, nuclear material, cow dung, propane, natural gas, biogas(methane), butane and petroleum. So, the operating mode of Stirling engine is becoming a great concern of the people.

Notwithstanding the fact that the mechanical design of Stirling engine is already well understood by the professionals in this field, many outstanding technical challenges are still encountered during its development. In this way, Stirling engine has not yet been widely applied. The so-called technical challenges refer to: performance, service life and heat transfer efficiency as well as cost. As for the heat transfer structure, a plain pattern is generally designed between the inner wall of Stirling engine's heated head and the dynamic piston or displacer (or scavenging piston). However, it is found during actual applications that, when external heat is introduced from the heated head, the heat cannot be rapidly guided into the central space between the inner wall of the heated head and dynamic piston (or displacer), thus affecting the thermal expansion efficiency and result of the high-temperature space, and making it difficult to improve greatly the performance of Stirling engine.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

Based on the unique configuration of the present invention wherein “the hot zone heat transfer structure of Stirling engine” allows the end wall of the heated head to be fitted with protruding heat conductors towards the piston, and the end surface of the piston to be fitted with a concave heat-conducting portion, this enables the heat from the heated head of Stirling engine to be transferred to the central area of the hot zone via the help of the protruding heat conductor and concave heat-conducting portion. So, this can increase the heat transfer area and range while improving greatly the heat transfer efficiency and thermal efficiency of Stirling engine with better applicability.

Moreover, based on the structural configuration wherein a bevelling portion is set onto the end of said protruding heat conductor or concave heat-conducting portion, the blockage can be avoided by the bevelling portion during the sliding process of the protruding heat conductor and concave heat-conducting portion.

Based on the structural configuration wherein a flanged section is set externally onto said protruding heat conductor towards the exterior of the end wall of the heated head, this can increase the contact area with heat and improve the thermal expansion efficiency and result of the hot zone.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a plan view of the preferred embodiment of the present invention (partial sectional view).

FIG. 2 is an operating view of the piston of the preferred embodiment of the present invention.

FIG. 3 is a partially enlarged view of the protruding heat conductor and concave heat-conducting portion of the present invention.

FIG. 4 is a schematic view of another preferred embodiment of the present invention showing the space pattern of Stirling engine.

FIG. 5 is a schematic view of another preferred embodiment of the present invention showing the space pattern of Stirling engine.

### DETAILED DESCRIPTION OF THE INVENTION

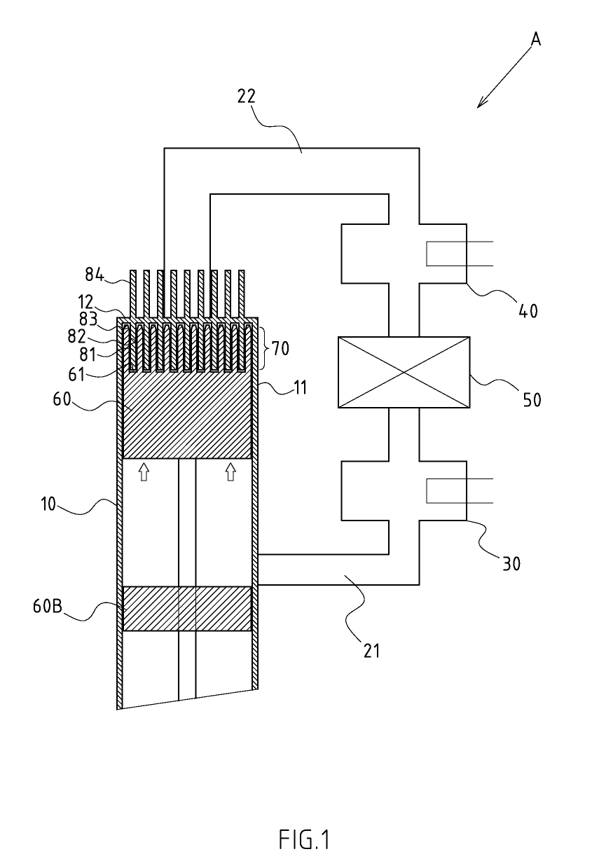

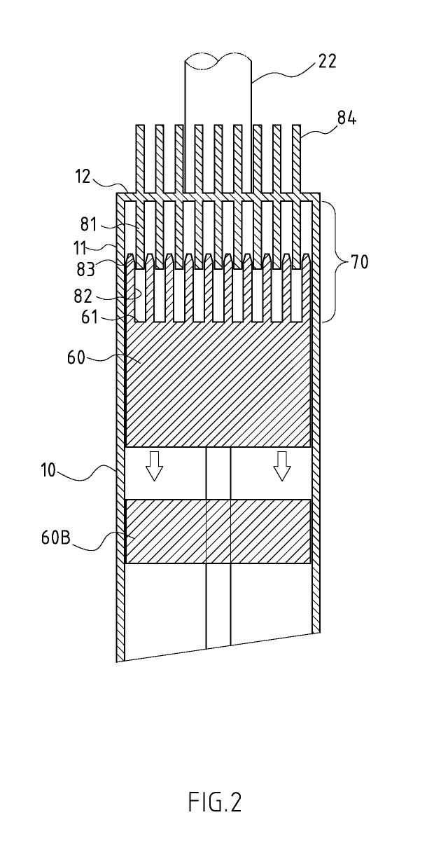

FIGS. 1-3 depict preferred embodiments of a hot zone heat transfer structure of a Stirling engine of the present invention, which, however, are provided for only explanatory objective for patent claims. The Stirling engine A comprises at least a cylinder 10, a cooling air pipe 21, a hot air pipe 22, a cooler 30, a heater 40 and a reheater 50. Of which, one end of the cylinder 10 comprises of a heated head 11, with the end wall 12 of the heated head 11 connected with the hot air pipe 22. The cylinder 10 accommodates at least a piston 60. The piston 60 is provided with an end surface 61 corresponding to the end wall 12 of the heated head 11, between which a hot zone 70 is defined. Moreover, the end wall 12 of the heated head 11 is fitted with at least a protruding heat conductor 81 towards the piston 60, and the end surface 61 of the piston 60 is fitted with at least a concave heat-conducting portion 82, enabling normal overlapping of the ends of both the protruding heat conductor 81 and the concave heat-conducting portion 82 (note: or disengagement when the piston 60 is withdrawn to the lower dead point). The overlapping of the ends of both the protruding heat conductor 81 and concave heat-conducting portion 82 may vary with the changing locations of the piston 60 (in collaboration with FIGS. 1, 2).

Of which, the piston 60 in the cylinder 10 is either a dynamic piston or a scavenging piston (or displacer).

Of which, said protruding heat conductor 81 can be configured into either of the following patterns: tube (or hot tube), hollow pipe, solid cylinder, plate or block containing heat-conducting medium. Said concave heat-conducting portion 82 is designed into a corresponding pattern.

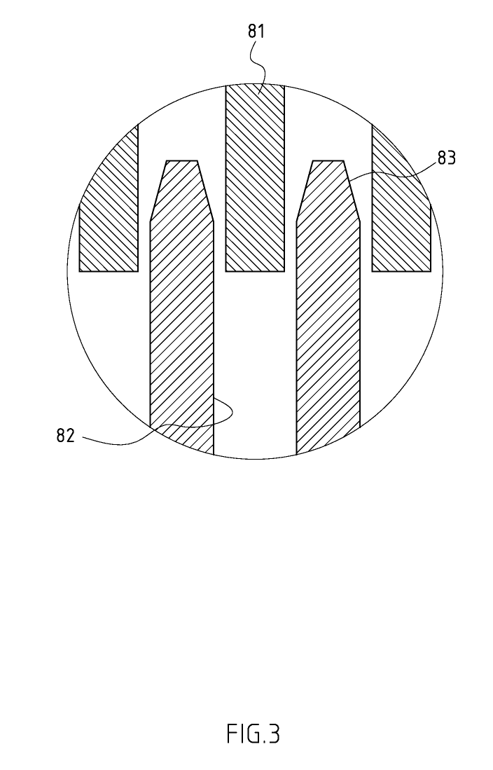

Referring to FIG. 3, a bevelling portion 83 is set laterally or peripherally onto the end of said concave heat-conducting portion 82. With the configuration of the bevelling portion 83, it is possible to prevent collision or blockage during relative displacement of the protruding heat conductor 81 and concave heat-conducting portion 82. Besides, said bevelling portion 83 can also be set laterally or peripherally onto the end of said protruding heat conductor 81 for the same purpose.

Of which, a flanged section 84 is set externally onto said protruding heat conductor 81 towards the exterior of the end wall 12 of the heated head 11, helping to increase the contact area of the end wall 12 of the heated head 11 and improving the thermal expansion efficiency and result of the hot zone 70.

Based on the aforementioned structural configuration, the present invention is operated as follows:

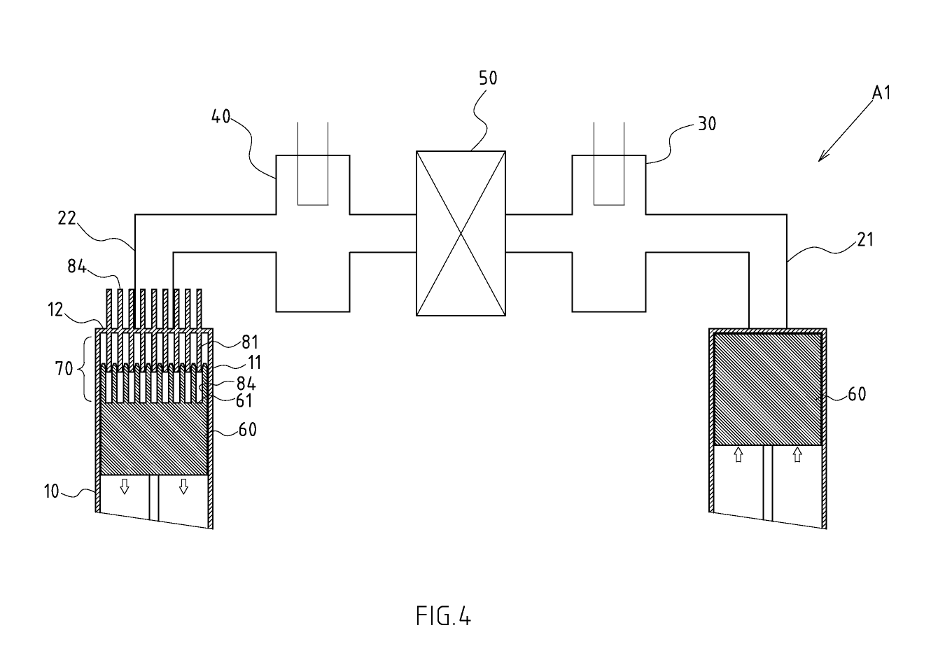

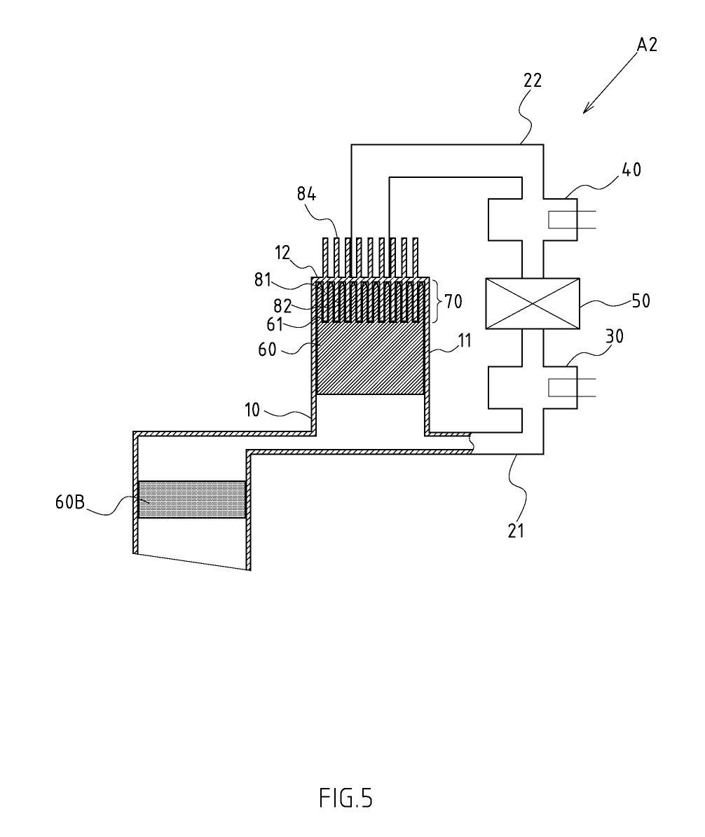

The space patterns of said Stirling engine A are illustrated in FIGS. 1, 4, 5, wherein FIG. 1 illustrates the preferred embodiment of β type Stirling engine A. Of which, said piston 60 is a scavenging piston, and the dynamic piston 60B is located at a spacing with the scavenging piston 60. FIG. 4 illustrates the preferred embodiment of α type Stirling engine A1. Of which, the piston 60 is a dynamic piston available with cool and hot sets in this preferred embodiment. FIG. 5 illustrates the preferred embodiment of γ type Stirling engine A2. Of which, the piston 60 is a scavenging piston, and the dynamic piston 60B is located at a spacing with the scavenging piston 60. The prefabricated framework of aforementioned α, β, γ Stirling engines A1, A, A2 can be applied to the hot zone heat transfer structure of the present invention, thus improving the thermal efficiency and performance of the Stirling engine.

1. A hot zone heat transfer structure of a Stirling engine, of which said Stirling engine comprises at least: a cylinder, cooling/hot air pipe, cooler, heater and reheater; of which one end of the cylinder comprises a heated head, and the end wall of the heated head is connected with the hot air pipe; the cylinder accommodates at least a piston; the piston is provided with an end surface corresponding to the end wall of the heated head, between which a hot zone is defined, the end wall of the heated head is fitted with at least a protruding heat conductor towards the piston, and the end surface of the piston is fitted with at least a concave heat-conducting portion, enabling normal overlapping of the ends of both the protruding heat conductor and the concave heat-conducting portion; the degree of the overlapping may vary with the changing locations of the piston; a flanged section is set externally onto said protruding heat conductor towards the exterior of the end wall of the heated head.

2. The structure defined in claim 1, wherein the piston in the cylinder is either a dynamic piston or a scavenging piston (or displacer).

3. The structure defined in claim 1, wherein said protruding heat conductor can be configured into either of the following patterns: tube (or hot tube), hollow pipe, solid cylinder, plate or block containing heat-conducting medium.

4. The structure defined in claim 1, wherein a bevelling portion is set laterally or peripherally onto the end of said protruding heat conductor or concave heat-conducting portion.

5. The structure defined in claim 1, wherein the ends of both the protruding heat conductor and concave heat-conducting portion can be overlapped to each other or disengaged from each other when the piston is withdrawn to the lower dead point.
